(19) United States
(12) Patent Application Publication
(10) Pub. No.: US 2002/0054324 A1
(43) Pub. Date: May 9, 2002

(54) Web print system and accouting method thereof

(76) Inventors: Yuji Okada, Takarazuka-Shi (JP); Takehito Tamaguchi, Hirakata-Shi (JP); Kenji Hisatomi, Neyagawa-Shi (JP)

Correspondence Address: MCDERMOTT WILL & EMERY, 600 13TH STREET, N.W., WASHINGTON, DC, 20005-3096, US

(21) Appl. No.: 09/895,806

(22) Filed: Jun. 29, 2001

(30) Foreign Application Priority Data
Jun. 29, 2000 (JP) 2000-195768

(51) Int. Cl. G06F 15/00

(52) U.S. Cl. 358/1.15

(57) ABSTRACT

This invention relates to a web print system comprising a web printer that acquires from a delivery server Internet information and then prints the Internet information. For example, the invention is a web print system comprising a web printer 10 that acquires Internet information like a web page 25a from a delivery server 20 and prints it out. Printing fee calculating means 24 calculates a printing fee on the basis of either one of a running cost needed for printing, a providing fee of the Internet information, or an advertisement rate per printing. Advertisement rate calculating means 27 calculates the advertisement rate on the basis of either one of the number of printing the advertisement, a term of the advertisement inserting, the size or content of the Internet information printed together with the advertisement, or a price decided at a auction by advertisers who intend to insert advertisements.

### BACKGROUND OF THE INVENTION

1. Field of the Invention

This invention relates to a web print system comprising a web printer for acquiring Internet information from a delivery server and performing the printing.

2. Description of the Related Art

It is general that a personal computer installing browser software called the web browser is used for printing Internet information such as web pages. Specifically, after a web page stored in the web server is acquired and displayed by the web browser, using the printing function of the web browser the web pages are transmitted to a printer connected with the personal computer and printed there.

Besides, a general method of designating a web page to be an object is to input a URL by means of operating means like a keyboard or a mouse. The URL (Uniform Resource Locator) means an addressing method for identifying Internet information uniquely.

However, the printing method requiring the above many procedures was very troublesome for a user and it caused the reduction of the working efficiency.

Therefore, Japanese laid-open Publication No. 11-316672 discloses a web printer that comprises the web browser function and the operating function as above and then enables to print out a web page by acquiring it direct from a web server (that is to say, not passing through a personal computer). Such web printer can print out the object web page in a simple way, so that it may improve the working efficiency.

By the way, if it is considered as a new business that the above conventional web printer is set up on a street and prints a web page, an accounting method gets to be a problem. Though it is easy to fix the charge in order to settle the problem, however, such fixing the charge is not acceptable to both the information provider of web page and the user.

In addition, a method has been well known that the price of magazine can be reduced if the publisher of the magazine collects the advertisement rate from the advertiser. However if the method is applied to the above printing business, there is a problem in the accounting for the advertiser.

### SUMMARY OF THE INVENTION

The invention is proposed on the basis of the conventional problems described above, and has an object to provide a web print system adopting a proper accounting mode.

The invention adopts following means in order to achieve the above object. That is to say, the invention is assumed to be a web print system comprising a web printer 10 that acquires Internet information such as a web page 25a or the like from a delivery server 20 and then prints it out, as shown in FIG. 1.

Printing fee calculating means 24 of the delivery server 20 calculates a printing fee on the basis of either one of a running cost needed for the printing, a providing fee of the Internet information, or an advertisement rate per printing. When the printing fee calculated by the printing fee calculating means 24 is collected from a user, the web printer 10 acquires the Internet information from the delivery server 20 and then prints it out. According to such configuration, it is possible to perform a proper accounting for both the provider of the Internet information and the user.

Advertisement rate calculating means 27 of the delivery server 20 calculates an advertisement rate on the basis of either one of the number of the advertisement printing, a term of the advertisement inserting, the size or content of the Internet information printed together with the advertisement, or a price decided at a auction by advertisers who intend to insert advertisements. According to such configuration, it is possible to perform a proper accounting for both the advertiser and the user.

Besides, the Internet information is not restricted to the web page. For instance, it may be an image file or a text file; those are sent and received through Internet.

### BRIEF DESCRIPTION OF THE DRAWINGS

FIG. 1 is a block diagram showing a web print system in the embodiment 1.

FIG. 2 is a block diagram showing a web print system in the embodiment 2.

FIG. 3 is a diagram showing the sequence of newspaper printing.

FIG. 4 is a diagram showing the status of a touch panel displaying a list of items to be printed.

FIG. 5 is a diagram showing the correlation of a web print system, an information provider, and an advertiser.

FIG. 6 is a block diagram showing a web print system in the embodiment 3.

FIG. 7 is a block diagram showing a web print system in the embodiment 4.

FIG. 8 is a block diagram showing another web print system in the embodiment 4.

FIG. 9 is a block diagram showing a web print system in the embodiment 5.

FIG. 10 is a block diagram showing a web print system in the embodiment 6.

FIG. 11 is a diagram showing a concrete example of searching result.

FIG. 12 is a diagram listing the searching results according to the priority order.

FIG. 13 is a diagram showing an example of inserting log composed of advertisement IDs.

FIG. 14 is a diagram showing an example of inserting log composed of advertisement IDs and registration time information.

FIG. 15 is a block diagram showing a web print system in the embodiment 7.

FIG. 16 is a block diagram showing a web print system in the embodiment 8.

FIG. 17 is a block diagram showing a web print system in the embodiment 8.

FIG. 18 is a block diagram showing another web print system in the embodiment 8.

### DETAILED DESCRIPTION OF THE PREFERRED EMBODIMENTS

The preferred embodiments of the invention will be explained in detail according to the drawings.

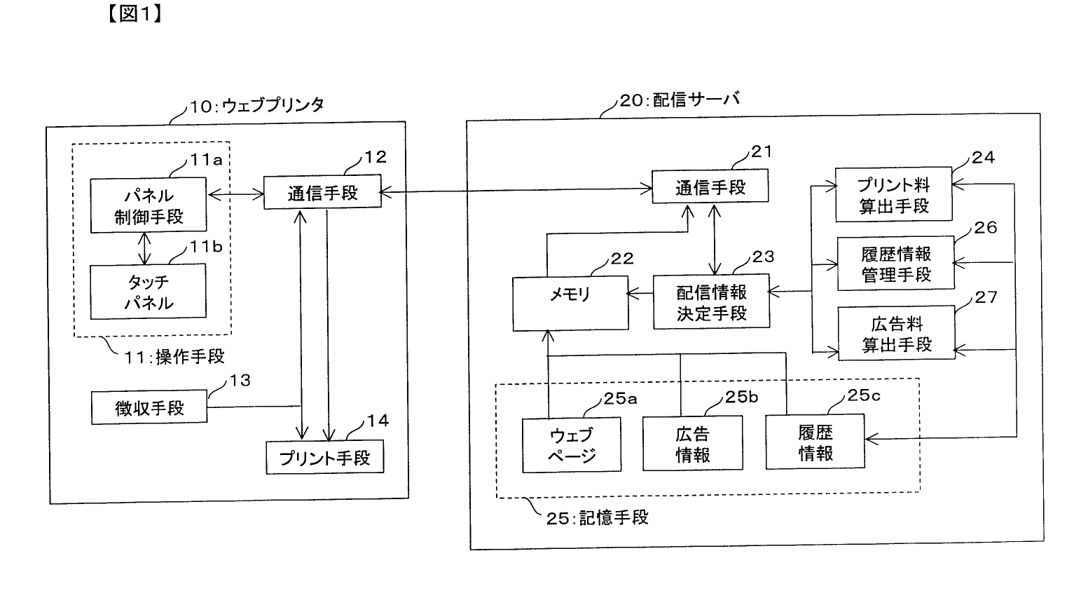

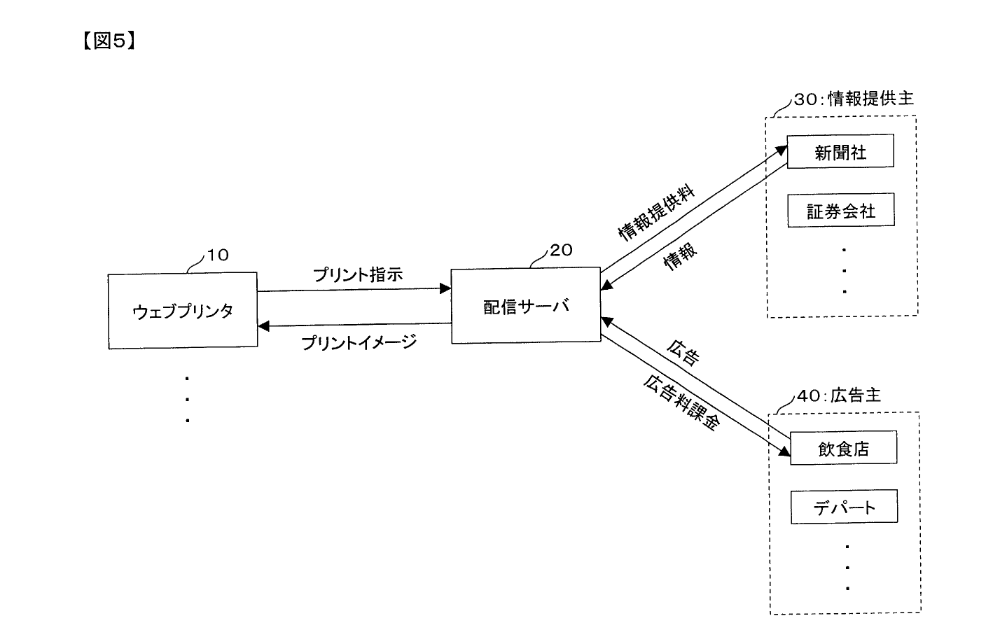

A web print system applying the invention comprises a plurality of web printers 10 and a delivery server 20 for delivering various types of information to the web printer 10, as shown in FIG. 5. It is presupposed in storage means 25 (a hard disk, or the like) of the delivery server 20 as shown in FIG. 1 that information acquired from a newspaper company or a security firm was previously stored as web page 25a, and an advertisement offered by a restaurant or a department was previously stored as advertisement information 25b.

Besides, in the following explanation, a management company of the web printers 10 and the delivery server 20 is called a “delivery company”, the newspaper company or the security firm is called an “information provider 30”, and the restaurant or the department store is called an “advertiser 40”.

Embodiment 1

FIG. 1 is a schematic functional block diagram showing a web print system in the embodiment 1.

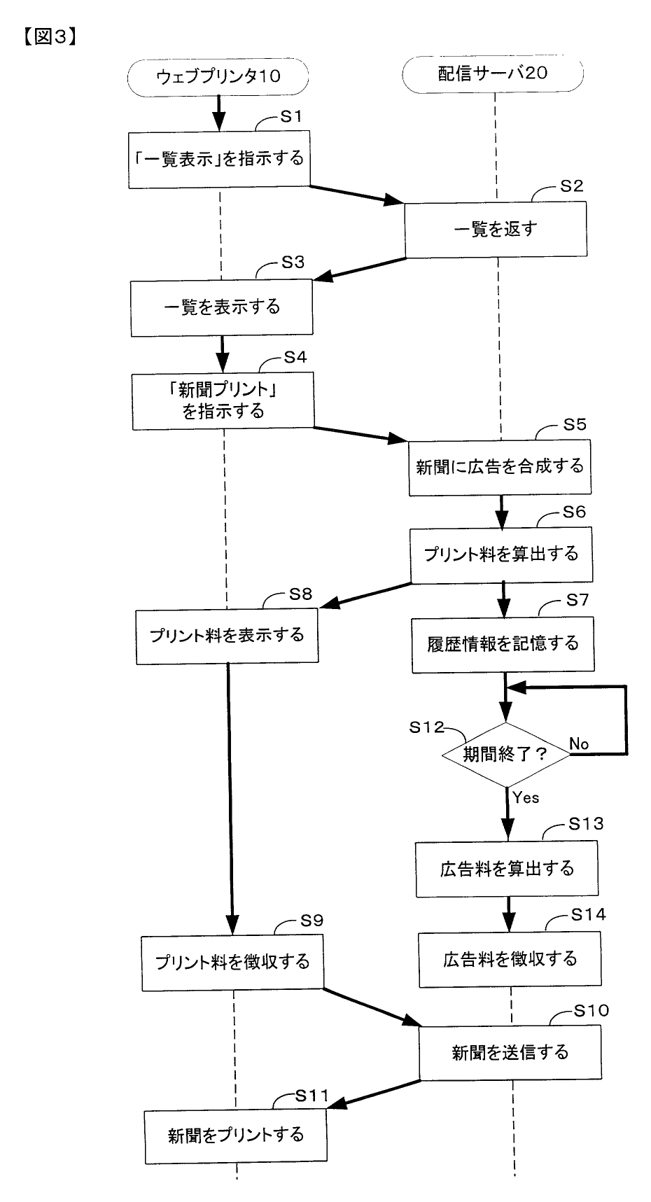

When a “list view” is selected from a touch panel 11b provided in the web printer 10, panel control means 11a on receipt of such instruction notifies communication means 12 of URL of web page 25a related to the “list view”. The communication means 12 on receipt of the notice sends a request to send the web page designated by the URL toward the delivery server 20 (Step S1 in FIG. 3).

Next, when the request to send the web page is received by delivery information deciding means 23 through communication means 21 of the delivery server 20, the delivery information deciding means 23 reads out the web page 25a related to the “list view” from the storage means 25 and sends it back to the web printer 10 (Step S2, FIG. 3).

Therefore the web page 25a is cashed in storage means (which is not shown) of the web printer 10, and then the panel control means 11a analyzes the web page 25a, which is displayed on the touch panel 11b (Step S3, FIG. 3).

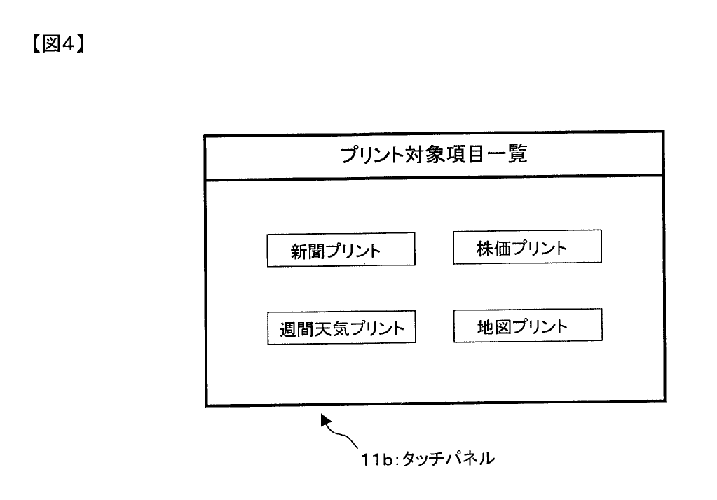

In result of the above procedures, a list of items to be printed is displayed on the touch panel 11b as shown in FIG. 4. The following explanation refers to the operation in case where a “newspaper printing” is selected (Step S4, FIG. 3).

Specifically, when the panel control means 11a on receipt of the instruction of the “newspaper printing” notifies the communication means 12 of the URL of the web page 25a related to the “newspaper”, a request to send the web page designating the URL is received by the delivery information deciding means 23 of the delivery server 20 as with the above operations. Besides, the URL of the web page 25a related to the “newspaper” is embedded in the web page 25a related to the “list view”.

The delivery information deciding means 23 reads the web page 25a related to the “newspaper” and the advertisement information 25b from the storage means 25 to a memory 22, and then combines the web page 25a and the advertisement information 25b (Step S5, FIG. 3). After that, the delivery information deciding means 23 instructs printing fee calculating means 24 to calculate the printing fee, and log information management means 26 to store log information.

Hereby, the printing fee calculating means 24 calculates as a printing fee the difference that the advertisement rate per printing subtracted from the sum of the running cost for printing and the information providing fee of the web page 25a is. The calculated printing fee is turned back to the delivery information deciding means 23 (Step S6, FIG. 3).

Besides, the running cost for printing means a communication fee between the web printer 10 and the delivery server 20, cost of the recording papers and the ink of the web printer 10, and so on. Therefore, it may be arranged that the panel control means 11a inquire of a user about relevant matters affecting these cost (for instance, whether the printing mode is the color mode or the monochrome mode, whether any image is embedded in the web page 25a or not, and the like), and the printing fee calculating means 24 calculates the printing fee according to the result of the inquiry. It is needless to say that the printing fee of the web page 25a printed in the monochrome mode is cheaper than that in the color mode, and the printing fee of the web page 25a including images is cheaper than that without images.

Additionally, the information providing fee of the web page 25a is a fee paid to the information provider 30 by the delivery company, and the advertisement rate per printing is a fee collected from the advertiser 40 by the delivery company (which will be described later).

After that, the printing fee calculated as above is received by the touch panel control means 11a of the web printer 10 through the communication means 21 and 12, and displayed by the touch panel 11b together with a message, “print this page at this printing fee?” (Step S8, FIG. 3).

Thereby, when a user pays the printing fee to colleting means 13 instead of the “cancel” instruction, the web page 25a related to the “newspaper” is transmitted from the delivery server 20 to the web printer 10. The newspaper is printed out from printing means 14 of the web printer 10 (Step S9 to S10 to S11, FIG. 3).

As described above, since it is arranged in the invention that the printing fee be calculated based on the information providing fee of the web page 25a, it is possible to make a proper accounting for both the information provider 30 and the user. That is to say, it is arranged that the amount paid to the information provider 30 by the delivery company be changeable according to the size or the content of the web page 25a, meanwhile the printing fee collected from a user by the delivery company be increased or reduced according to the change.

This embodiment takes as an example the operation that the advertisement never fails to be printed together at the time of printing the web page 25. However, it is preferable to inquire of a user about whether the advertisement should be printed or not. That is to say, it is arranged in the invention that a message like “print the advertisement?” be displayed on the touch panel 11b. When a user selects not to print the advertisement, only the web page 25a may be printed. On the other hand, when the user selects to print the advertisement together, the web page 25a may be printed combining with the advertisement information 25b.

In this embodiment, the difference that the advertisement rate per printing subtracted from the sum of the running cost for printing and the information providing fee of the web page 25a is may be calculated as the printing fee. However, the printing fee may be calculated on the basis of at least either one of the running cost for printing, the information providing fee of the web page 25, or the advertisement rate per printing. For instance, in case of not printing the advertisement, the sum of the running cost for printing and the information providing fee of the web page 25a should be the printing fee.

On the other hand, the log information management means 26, which is instructed to store log information by the delivery information deciding means 23, correlates the present time with file names of the web page 25a and the advertisement information 25b that are read out from the storage means 25, and with a machine ID of a destination of the web page 25a and the advertisement information, which are stored in the storage means 25a as log information 25c (Step S7, FIG. 3).

Here, when a term of an advertisement inserting expired (Step S12: YES, FIG. 3), advertisement rate calculating means 27 calculates as a advertisement rate the amount that the advertisement rate per printing multiplied by the number of printing is, and then transfers the calculated advertisement rate to advertisement rate collecting means that is not shown in the drawing (Step S13, FIG. 3).

The number of printing is the number of times that the advertisement is printed. The number of printing can be found by referring to the log information 25c in the storage means 25. Additionally, the advertisement rate collecting means is equivalent to means for collecting the advertisement rate from the advertiser 40 (Step S14, FIG. 3), of which the collecting method and the collecting timing are not restricted in particular.

As described above, since it is arranged in the invention to calculate as the advertisement rate the amount that the printing fee per printing multiplied by the number of printing is, it is possible to perform the proper accounting for both the user and the advertiser 40. That is to say, while the user's expense is reduced by collecting the advertisement rate from the advertiser 40, the advertisement rate collected from the advertiser 40 is to be the amount corresponding to the number of printing in fact.

The example in this embodiment shows an operation of printing a newspaper as soon as the “newspaper printing” is selected out of a list of items to be printed, however, it may be arranged that the summary of the newspaper be displayed on the touch panel 11b in the first place. According to such configuration, since a user can select to print or not print after confirming the content of the summary, it is convenient for the user.

In addition, it is preferable that the advertisement rate per printing is determined on the basis of items affecting the effect of the advertisement, such as the term (time) of the advertisement inserting, the size or content of the web page 25a printed together with the advertisement (the advertisement printed together with a small quantity of the web page 25a is larger in the effect than that with a large quantity of the web page 25a). The “term of the advertisement inserting” may be stored in the storage means 25 in advance, and the “web page 25a printed together with the advertisement” can be found out by referring to the log information 25c in the storage means 25.

Moreover, an auction will be held for advertisers 40 that intend to insert advertisements, and the prince decided at this auction may get to be the advertisement rate. The method for the auction is not restricted in particular.

Furthermore, the above explanation (Step S5, FIG. 3) does not refer to a kind of advertisement to be combined with the web page 25a, but it is preferable to inquire of a user about the kind of advertisement. That is to say, as described above, the touch panel 11b displays a message such as “print the advertisement?” Thereby, when the printing of the advertisement is selected, it is arranged to display additionally on the touch panel 11b a button indicating the kind of advertisement like a “want ad” button or a “bargain” button. And then the kind of advertisement selected here may be combined with the web page 25a. According to such arrangement, the printing is performed only for his interested kind of advertisement, so that it is convenient for a user. In addition, according to the kind of advertisement selected as described above, the advertisement rate per printing may be determined.

Embodiment 2

By the way, in case where the kind of advertisement and so on are selected by a user, there is a problem of the layout of the web page 25a. That is to say, it can be considered a method for ensuring sufficiently large spaces for advertisement in advance, but such method is not preferable because unnecessary blank generates and the space of paper gets to be wasted.

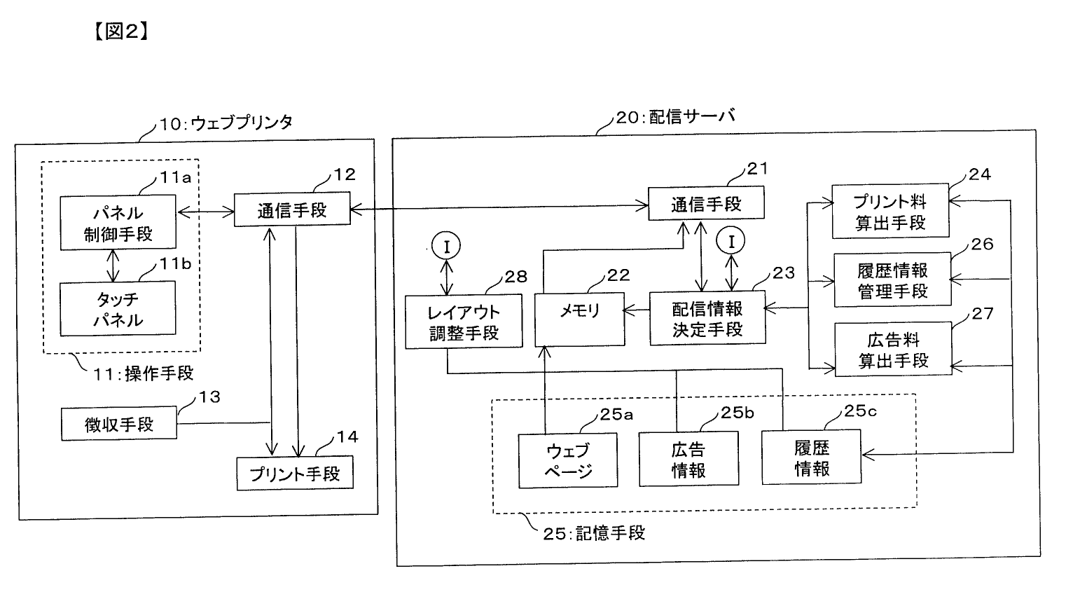

Therefore, this embodiment of this invention adopts a configuration comprising layout adjusting means 28 for adjusting a layout of the web page 25 as shown in FIG. 2. The configuration is explained hereafter regarding the points different from that of the embodiment 1.

By selecting the “newspaper printing” from the list of items to be printed, the web page 25a and the advertisement information 25b related to the “newspaper” are read from the storage means 25 of the delivery server 20 to the memory 22, of which operations are the same as that of the embodiment 1.

Here, the delivery information deciding means 23 instructs the layout adjusting means 28 to adjust the layout of the web page 25a, and the layout adjusting means 28 on receipt of the instruction optimize the layout of the newspaper articles, the form of the paragraphs, and the size of the advertisement information 25b, so as not to generate any blank (such optimization algorithm has been well known).

After completing the adjustment of layout, the delivery information deciding means 23 instructs the printing fee calculating means 24 to calculate the printing fee as is the case with the embodiment 1, and simultaneously instructs the log information management means 26 to store the log information.

According to the above configuration, the invention can provide a printing result with less blank, so that the cost of papers and ink may be reduced, and the printing fee goes down.

This embodiment takes as an example an operation for adjusting the layout so as not to generate any blank, but it may be arranged that the layout adjusting means 28 carry out the various functions explained as follows.

(Automatic Page Skipping Function)

It is generally assumed that the web page is browsed by a display of a personal computer, and it is arranged that clicking the link resented by blue characters or the forward button by a mouse permit to trace the related web pages (the page skipping). Therefore, a user of a personal computer can display on a display web pages in sequence skipping the pages, and print out only desired pages out of those pages.

On the other hand, the web printer 10 is a device improved in order to print the web pages efficiently. That is to say, when the web printer 10 is instructed to print the web page, it is preferable that the relevant web pages be printed together.

Accordingly, if there are any pages related to the web page 25a to be printed, the layout adjusting means 28 reads the relevant pages from the storage means 25 to the memory 22. And then the read relevant pages are transmitted from the delivery server 20 to the web printer 10, which are printed by means of the printing means 14 of the web printer 10 together with the web page 25a to be printed.

The judgment whether there is relevant pages or not can be determined by detecting the URLs embedded in the web page 25 to be printed.

(Font and Total Page Number Changing Function)

If it is possible to change the style of type, the font of type, the size of image, or the quality of image according to user's request, it is very convenient for a user. According to such configuration, it is possible to print out the web page in large sized font for a user who is hard to read those in small sized font, or to print out the web page in small sized font for a user who wants to reduce the printing fee.

Hereby, when a user instructs to print the web page 25a, the panel control means 11a on receipt of this instruction is arranged to display a screen for selecting a font on the touch panel 11b. The font selected here is transmitted to the delivery server 20 together with the request to send the web page, and then the layout adjusting means 28 of the delivery server 20 changes the font of type included in the web page 25a to the selected one (the operation that the layout adjusting means 28 changes the size or the quality of image is the same as this).

Beside, when the total page numbers to be printed may be selected instead of selecting the font of type, the layout adjusting means 28 may adjust the size of image or the font so as to store them just in the selected number of total page.

(Serial Number Imparting Function)

If there is a plurality of web page 25a to be printed, the layout adjusting means 28 may impart a page number in a header or a footer of each page.

It may be arranged that serial numbers are imparted in the web page 25a, for example, if the page number printed last is 100, the next page number to be printed gets to be 101. Accordingly, at the time of filing the printed web pages 25a, it is convenient for a user (though the web pages 25a can be filed in the printed order according to the date of printing, it is hard to know only by the date whether the filed web page 25a has any missing page or not).

When the serial numbers are imparted as described above, it is necessary to identify a user of the web printer 10. But the method will be described later.

(Marking Function)

When a printer is used at home, a user wants to use both sides of paper. But, the double sides printer has a large volume and is expensive, so that a user be used to set a paper upside down and print on an unused side. However, when a user is going to print on both sides in manual, it sometimes happens that the printing is overlapped on one side by mistake.

Therefore, it may be arranged that the layout adjusting means 28 impart in the web page 25a mark information so as to print a specific mark (black dot) on four corners of paper or on opposite angles. Accordingly, the printing side of a paper set in the web printer 10 is detected by a sensor (not shown in drawings), and if the mark is detected on the printing side, the touch panel lib can display an alerting message. In result, it is possible to avoid the overlapped printing.

(Batch Printing Function)

When a user repeats an operation to select a frame inserting information that he wants to print and to instruct to print them, the printing is executed per frame, thereby the printed paper includes much blank. The frame is a method applied to the preparation of web pages and is for dividing a screen into plural regions.

Therefore, it is preferable to execute a following batch printing instead of the prescribed on-demand printing. That is to say, a plurality of information to be printed is stored in the memory 22 of the delivery sever 20 temporarily until the touch panel 11b issues a printing instruction finally. Thereby, since it is possible to adjust and print the layout of the plurality of information at the time of the final instruction of printing, the invention can provide a user with printed papers with less blank.

Embodiment 3

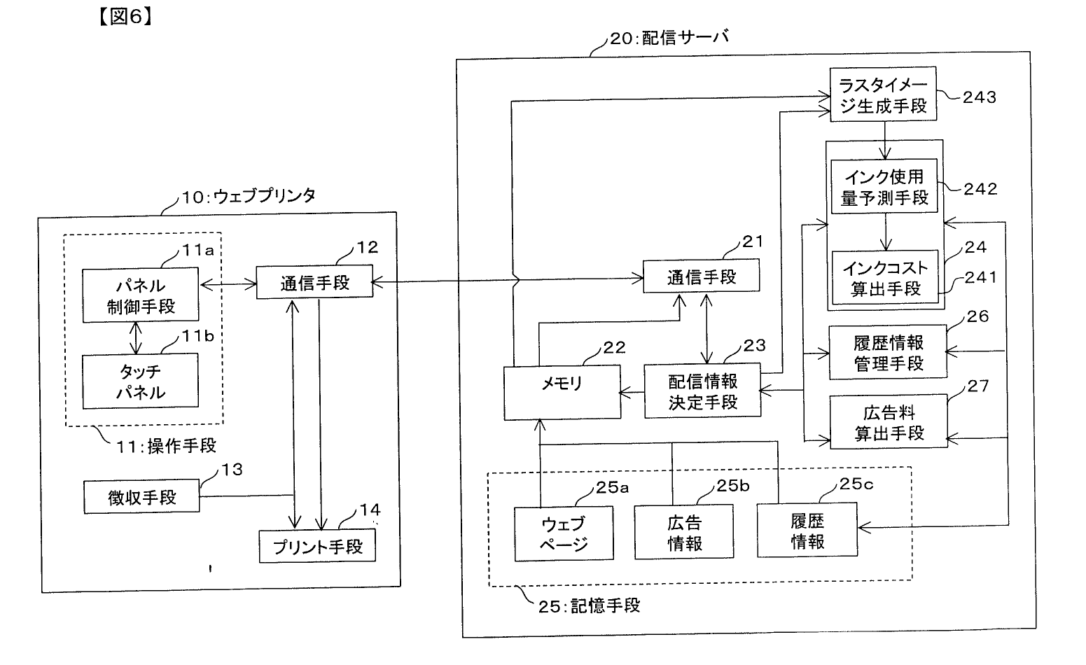

In the delivery server 20 as shown in FIG. 6, for example, the printing fee calculation means 24 comprises ink cost calculating means 241. The ink cost calculating means 241 calculates the cost of ink of the running cost.

There is a possibility that the cost of ink may change sharply according to the web page 25a to be printed. It is not impossible to estimate the cost of ink according to the size of printing paper, however, it is afraid that such estimation causes the improper fee.

Therefore, the ink cost calculating means 241 calculates the cost of ink on the basis of the result estimated by ink use estimating means 242 provided in the printing fee calculating means 24.

The ink use estimating means 242 estimates the used ink volume needed for printing the web page 25a according to the printing image of the web page 25a.

Here, the printing image is equivalent to an image to be actually printed by the web printer 10, for instance, bitmap data obtained in result of rasterizing. This bitmap data represents a value of density of each color per pixel, is generated by raster image generating means 243. When instructing the printing fee calculating means 24 to calculate the printing fee, the delivery information deciding means 243 instructs the raster image generating means 243 to generate bitmap data.

The raster image generating means 243 on receipt of the instruction reads out an image of the web page 25a combined with the advertisement information 25b from the memory 22. If the image is compressively coded, the raster image generating means 243 decodes the image and then generates the bitmap data. However, since the bitmap data represents the brightness of RGB, the colors are converted corresponding to the color of ink. Thereby the bitmap data represented by the density of CMY is generated.

The bitmap data generated by the raster image generating means 243 is configured so that <CαMβYγ> data representing respective density of CMY of each pixel may be disposed as much as the number of horizontal pixels multiplexed by the number of vertical pixels. In this case, respective α, β and γ represent a density of each color: cyanogens (C); magenta (M); and yellow (Y).

A table or a function representing the correlation between the density and the used ink volume is stored in the ink use estimating means 242 in advance. The ink use estimating means 242 converts the density to the used ink volume per color of every pixel of the bitmap data, with reference to the table registered in advance, for example. Each used ink volume for every pixel is added up per color. Thereby, the used ink volume of each color may be estimated as C: 2.6 ml, M: 20.7 ml, and Y: 13.4 ml, for example.

In this case, the ink cost calculating means 241 multiplies the ink fee per a unit of volume by the used ink volume of each color. When the ink fee per unit of volume is ¥2/ml, the ink cost of the cyanogens is found as 2.6 ml×2 yen/ml=¥5.2. Likewise, the ink costs of other colors are found respectively. The cost calculating means 241 calculates the ink cost included in the running cost by adding the ink costs of every colors.

In such a way, by estimating the used ink volume needed for the printing according to the printing image, the ink cost can be calculated with comparative precision. In result, it is possible to perform the proper accounting regardless of the web page 25a to be printed.

Furthermore, by acquiring in advance from the web printer 10 a parameter such as an output resolution inputted by the operating means 11, it is possible to estimate exactly according to the parameter.

Moreover, though the above-mentioned example describes that the used ink volume is estimated, it is needless to say that the used volume of toner or other coloring agents may be estimated according to the kind of web printer 10.

It is quite natural that the cost of ink and others used for printing advertisement, which are included in the running cost, should be charged to the advertiser 40 essentially. The printing fee of a user may not include the cost needed for the printing the advertisements. In case of the above-mentioned example, instead of calculating the running cost for the image of the web page 25a combined with the advertisement information 25b, the printing fee calculating means 24 may calculate the running cost only for the image of the web page 25a. Thereby, the running cost needed for printing the advertisements is not included in the printing fee.

Embodiment 4

The ink cost used for printing the advertisements is included in the advertisement rate collected from the advertiser 40 by the delivery company. Like the web page 25a, there is a possibility that the ink cost used for printing the advertisement information 25b changes sharply according to the advertisement information 25b.

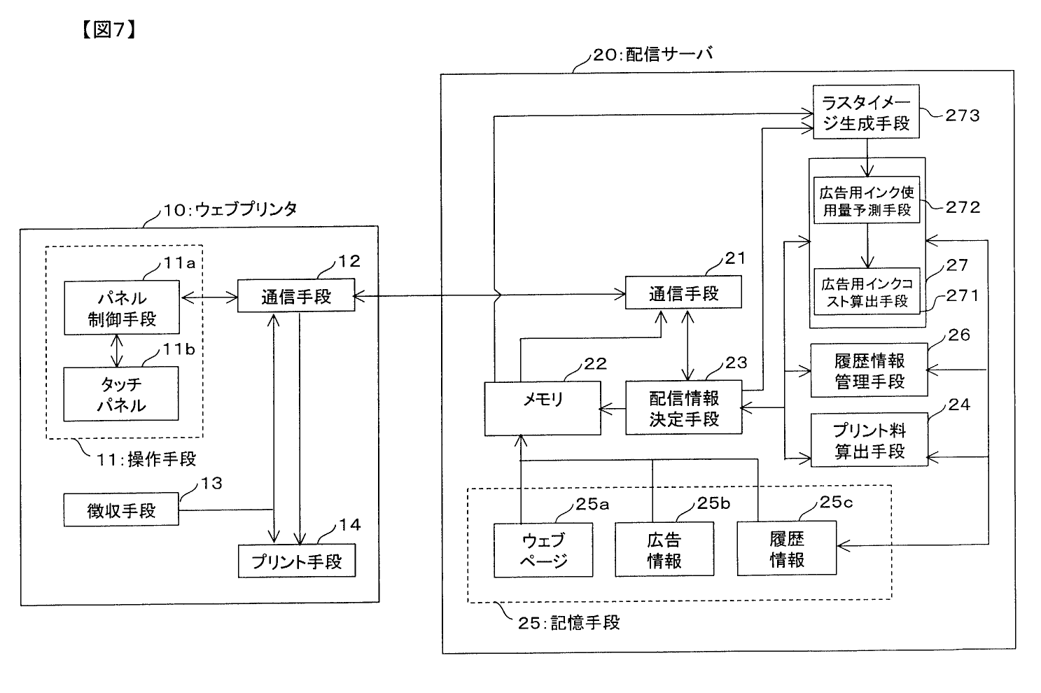

Therefore, in the delivery server 20 shown in FIG. 7, the advertisement rate calculating means 27 comprises ink use for advertisement estimating means 272 in addition to ink cost for advertisement calculating means 271.

The ink use for advertisement estimating means 272 estimates the used ink volume needed for printing the advertisement information 25b according to the printing image of the advertisement information 25b. The processing performed by the ink use for advertisement estimating means 272 is essentially the same as that of the ink use estimating means 242 except a point that the printing image is the advertisement information 25b.

The printing image of the advertisement is generated by raster image generating means 273. The raster image generating means 273 essentially performs the processing as well as the raster image generating means 243, except the object of processing is the advertisement information 25b. Therefore, the printing fee calculating means 24 and the advertisement rate calculating means 27 can share the same raster image generating means.

After generating bitmap data of the advertisement information 25b, the raster image generating means 273 provides it to the ink use for advertisement estimating means 272. With reference to the table registered in advance, for instance, the ink use for advertisement estimating means 272 changes the density to the used ink volume; the density of each color regarding every pixel of the bitmap data of the advertisement information 25b. And by adding the used ink volume of every pixel per color respectively, the used ink volume per color can be estimated.

After the used ink volume per color is estimated by the ink use for advertisement estimating means 272, the ink cost for advertisement calculating means 271 finds the ink cost per color respectively by multiplying the ink fee per unit of volume by the used ink volume of each color. And then the ink cost for advertisement calculating means 271 calculates the ink cost by adding the ink cost of all colors.

The advertisement rate calculating means 27 calculates the advertisement rate on the basis of the ink cost calculated by the ink cost for advertisement calculating means 271.

Thereby, it is possible to calculate the proper advertisement rate regardless of the advertisement information 25b to be printed.

Besides, though the above example describes that the used ink volume is estimated, it is needless to say that the used volume of toner or other color agents may be estimated according to the kind of the web printer 10.

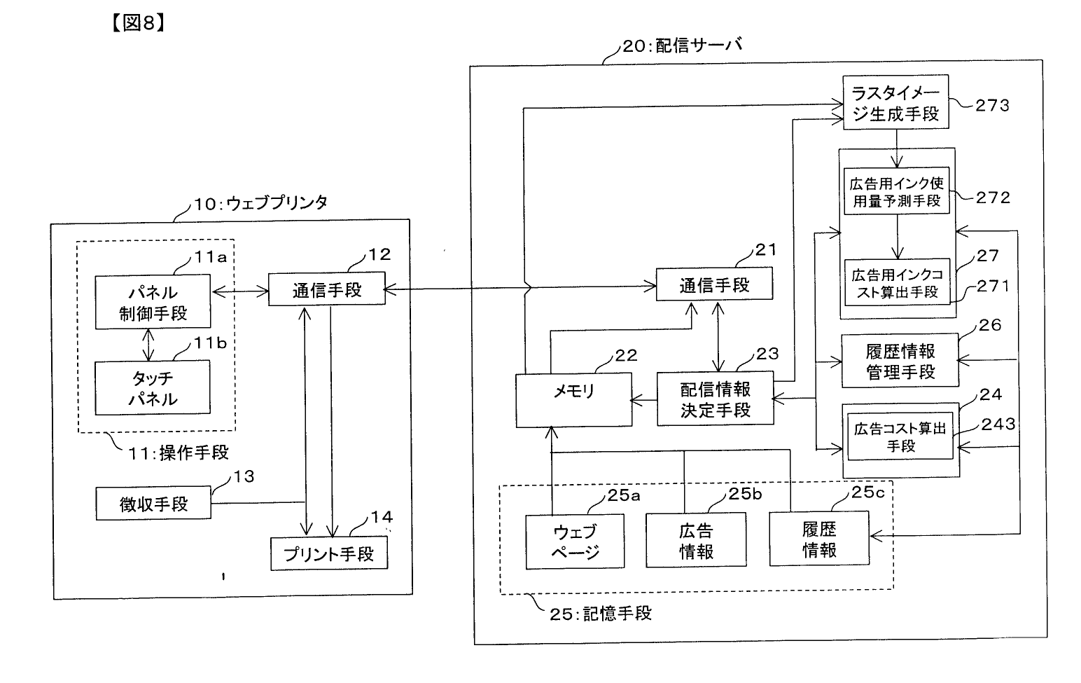

In addition, it is possible to apply the result calculated by the ink cost for advertisement calculating means 271 to the calculation of the printing fee. In the delivery server 20 shown in FIG. 8, the printing fee calculating means 24 comprises advertisement cost calculating means 243. For instance, using the result calculated by the ink cost for advertisement calculating means 271, the advertisement cost calculating means 243 calculates the running cost needed for printing the advertisements on the basis of the printing image of the advertisement. More specifically, the advertisement cost calculating means 243 calculates the running cost needed for printing the advertisement by adding other costs except ink and the calculation result of the ink cost for advertisement calculating means 271. And then the printing fee calculating means 24 discounts the printing fee being collected from a user as much as the calculation result of the advertisement cost calculating means 243. Thereby, it is possible to arrange that the running cost needed for printing the advertisement be not included in the printing fee.

Embodiment 5

In case where same one user repeats to print the information that he has printed before, each piece of the printed information overlaps the other. Specifically, it is the case where the user prints information, but the printed result is different from the one he expected, therefore he prints the same information after changing the printing mode. Even in such case, it is cruel to charge the printing fee to a user. Accordingly, it is arranged in this case that the information providing fee be not included in the printing fee, otherwise the information providing fee to be included in the printing fee be discounted in advance. Whether a user performs an overlap printing or not can be known by referring to the log information 25c stored in the storage means 25. For instance, the log information 25c correlates a user ID and the web page 25a that was printed in the past. It may use as the user ID the one that was transmitted from the web printer 10 to the delivery server 20 in response to the request to send the web page 25a in the past.

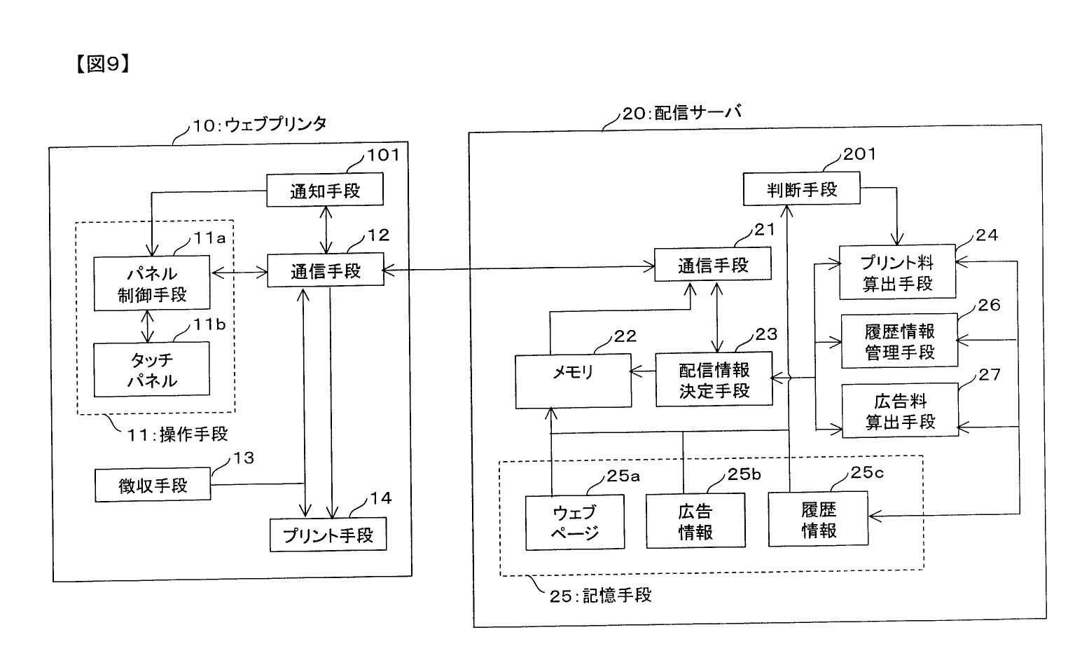

The delivery server 20 shown in FIG. 9 comprises judging means 201. The judging means 201 judges whether the printing matter is the information printed in the past. For instance, the judgment is performed on the basis of the correlation in the log information 25c between the web page 25a that is requested by a request to send the web page 25a and the user ID that is received together with the request to send the web page 25a.

If the web page 25a and the user ID are correlated each other in the log information 25c, the judging means 201 judges that the web page 25a was printed in the past. If the web page 25a and the user ID are not correlated each other in the log information 25c, the judging means 201 judges that the web page 25a was not printed in the past. At the time of judging that the web page was printed in the past, the judging means 201 outputs the judgment result to the printing fee calculating means 24. In case of inputting the judgment result that the information was printed in the past, the printing fee calculating means 24 calculates the printing fee on the basis of the fee to which the information providing fee is discounted, instead of the information providing fee.

For instance, even if the providing fee of the web page 25a is ¥10, when the web page was printed in the past, the printing fee may include ¥4 that ¥6 taken off the providing fee is. Otherwise the whole amount of the providing fee may be discounted from the printing fee; thereby the providing fee of the web page 25a may not be included in the printing fee. Additionally, when the web page 25a was printed once in the past, the printing fee should not include the providing fee ¥10 but include ¥4 that ¥6 taken off the providing fee is. On the other hand, when the web page 25a was printed twice in the past, the printing fee should include ¥2 that ¥8 taken off the providing fee is. In such a way, it may be arranged that the discount rate should be changed according to the number of printing in the past.

As described above, since the printing fee calculating means 24 calculates the printing fee for the information printed in the past on the basis of the fee to which the providing fee is discounted, even when a user prints the same information again by mistake, it is possible to avoid that the multiple accounting increases the charge of the user.

Moreover, if a use finds in advance that the web page was printed in the past, maybe he will think that it is not necessary to print it again. Therefore, when the judging means 201 judges that the information was printed in the past, it is preferable to notify the user of the message.

In this case, the judging means 201 sends a notice of the reprinting to notifying means 101 through the communication means 21 and 12. On receipt of the notice of reprinting, the notifying means 101 displays a message to inform the reprinting on the touch panel 11b by means of the panel control means 11a, which is informed to the user.

At this time, the touch panel 11b displays a message such as “This page was printed in the past. Do you proceed with the printing?” for example. If the user determines that it is not necessary to perform the reprinting, he may instruct to cancel the processing against the message.

Thereby, it is possible to avoid the surplus charge to a user and the needless printing.

Embodiment 6

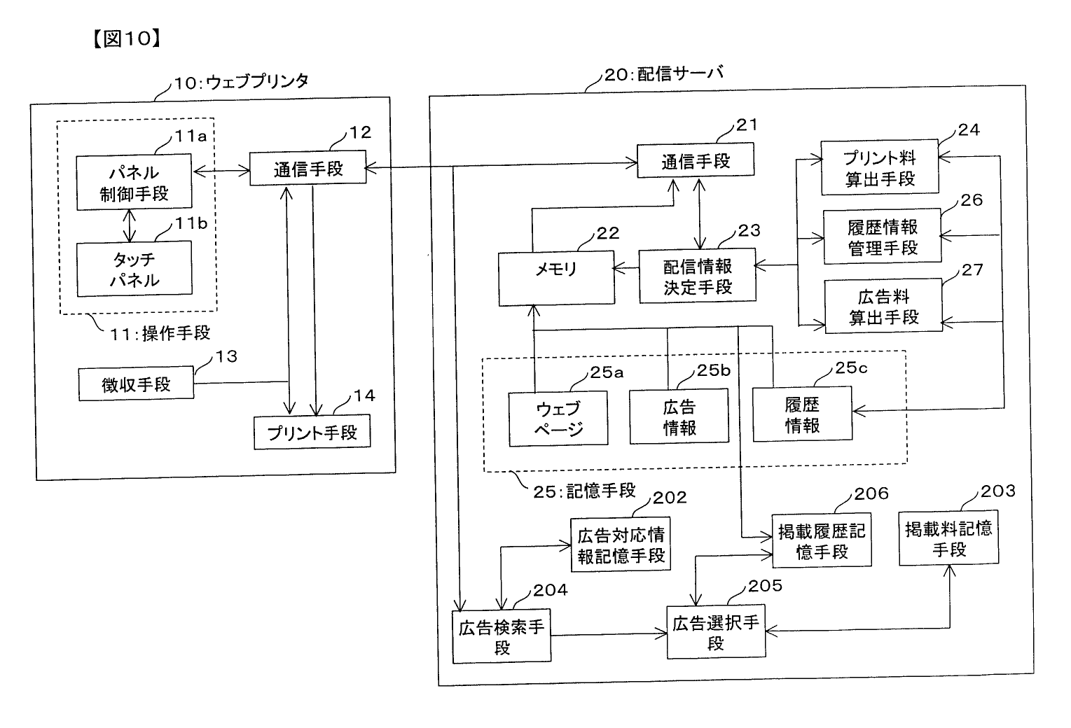

Naturally the effect of the advertisement inserted in the information increases more when the advertisement is related to the information and a user who prints the information. Therefore, the delivery server 20 shown in FIG. 10 comprises advertisement correspondence information storage means 202. The advertisement correspondence information storage means 202 is for storing advertisement correspondence information correlating with following items: the advertisement information 25b; the web page 25a itself; information related to the web page 25a; and personal information. A materialized examples of the information related to the web page 25a are a genre (filed) of contents described in the web page 25a, a keyword contained in the description of the web page 25a, or the like. And the personal information contains the address, the distinction of sex, the age, the interests, and so on.

The advertisement correspondence information is transmitted to the delivery server 20 together with the advertisement information 25b when the advertiser 40 registers the advertisement information 25b in the delivery server 20. For instance, after displaying an input form on a terminal of the advertiser 40, the inputted content may be posted to the delivery server 20 from the terminal of the advertiser 40.

The delivery server 20 also comprises inserting rate storage means 203. The inserting rate storage means 203 is for storing the inserting rate of the advertisement, and may use physically the same one as the advertisement correspondence information storage means 202. The inserting rate of the advertisement is a charge paid to the delivery company by the advertiser 40 when the advertisement is inserted. The delivery company may use the inserting rate for providing the services or may refund a part of the inserting rate to a user.

Regarding the inserting rate of the advertisement, when the advertiser 40 registers the advertisement information 25b in the delivery server 20, after displaying the input form on the terminal of the advertiser 40, the inputted content may be posted to the delivery server from the terminal of the advertiser 40.

The delivery server 20 further comprises advertisement searching means 204 and advertisement selecting means 205. The advertisement searching means 204 searches in the storage means 25 an advertisement corresponding to either one of the web page 25a to be printed, the related information, or the personal information of user who instructs the printing, on the basis of the advertisement correspondence information.

The searching of the advertisement by the advertisement searching means 204 may starts when the advertisement selecting means 205 outputs the a request to search to the advertisement searching means 204.

On receipt of a request to send the web page 25a from the web printer 10, for example, the advertisement selecting means 205 outputs a request to search to the advertisement searching means 204. At the time, the advertisement selecting means 205 selects as the searching conditions the web page 25a that is requested to send, the related information of the web page 25a, and the user ID for identifying the user who instructs the request to send. The user ID may use the one that the panel control means 11a requests a user to input and the delivery server 20 authenticates.

The result that the advertisement searching means 204 searches in accordance with the searching conditions is provided to the advertisement selecting means 205. And there is a possibility that the searching result includes a plurality of advertisements.

The advertisement selecting means 205 selects an advertisement to be inserted in the web page 25a from the advertisements included in the searching result on the basis of at least either one of the inserting rate of the advertisement or the inserting log.

The inserting log of the advertisement is a history of the advertisement identification information (advertisement ID, etc.) for identifying the advertisement, for example. Inserting log storage means 206 is storage for storing the inserting history of the advertisement per user, and may physically use the same one as the advertisement correspondence information storage means 202.

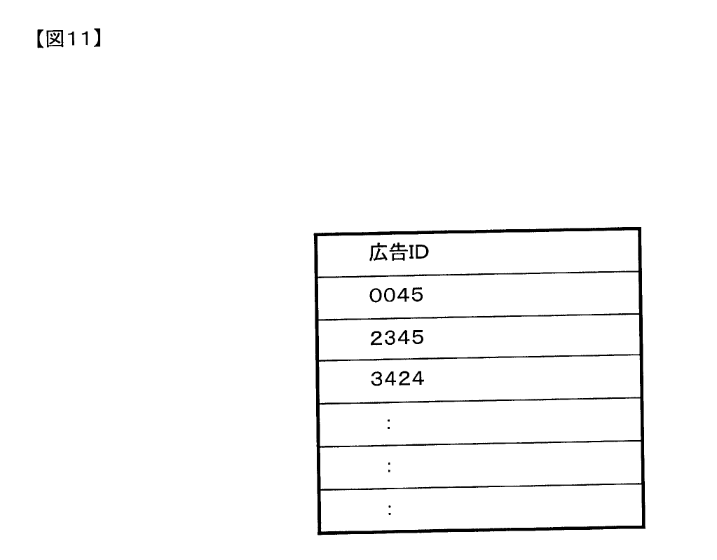

Here, the searching result of the advertisement searching means 204 is shown in FIG. 11 practically. As shown in FIG. 11, the searching result contains a plurality of advertisement IDs, such as 0045, 2345, 3424, . . . and etc.

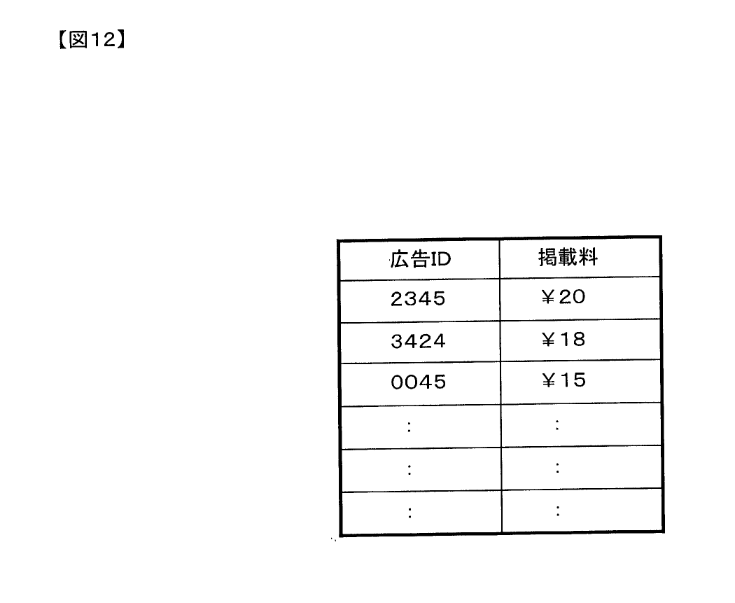

The advertisement selecting means 205, referring to the inserting rate storage means 203, disposes the advertisement IDs included in the searching result in the order of high price, as shown in FIG. 12. That is to say, the priority order of advertisements to be inserted in the web page 25a is set in the order of the high inserting rate. In FIG. 12, the inserting rate of an advertisement identified by the advertisement ID 2345 is ¥20. Since it is the highest rate, the advertisement is set at the highest position.

The advertisement selecting means 205, referring to the inserting log storage means 206, confirms that the advertisement ID included in the searching result is contained in the history of user who makes the web printer 10 issue a request to send. For instance, if the advertisement ID is included in the inserting log, the advertisement selecting means 205 judges that the advertisement information 25b identified by the advertisement ID was inserted in the web page 25a printed in the past by the user.

In case of judging that the advertisement information 25b identified by the advertisement ID was printed in the past, the advertisement selecting means 205 excludes the advertisement information 25b from objects to be inserted in the web page 25a, or reduces its priority order lower.

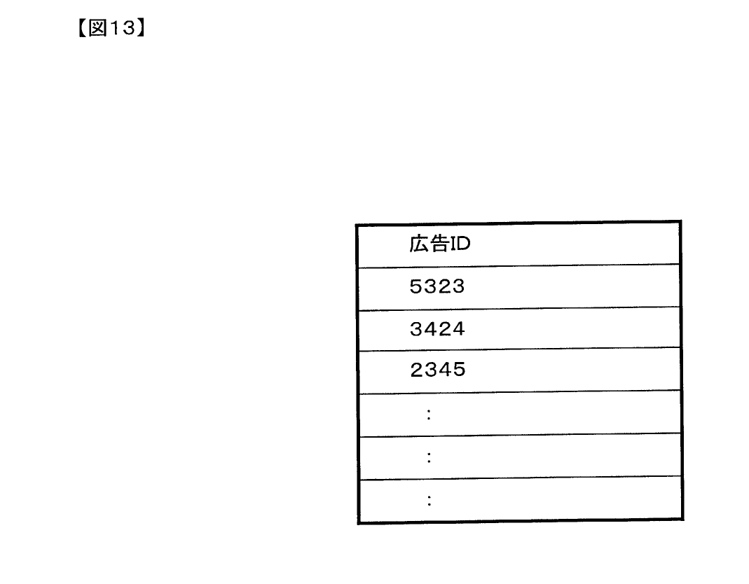

Here, the inserting log of a user who makes the web printer 10 issue a request to send is represented as the one shown in FIG. 13, for example. The inserting log contains advertisement IDs such as 5323, 3424, 2345, . . . , as shown in FIG. 13.

In this case, the advertisement selecting means 205 excludes advertisement IDs 2345 and 3424 included in the searching result from objects to be selected because those IDs are contained in the inserting log. And the advertisement selecting means 205 selects the advertisement of the highest priority from the objects to be selected as the advertisement being inserted in the web page 25a to be printed. In the example shown in FIG. 12, an advertisement of high priority next to the advertisement identified by 2345 and 3424 that is identified by advertisement ID 0045 is selected.

As described above, according to the advertisement inserting rate and the inserting log, the advertisement selecting means 205 selects an advertisement to be inserted in the printing information from advertisements included in the searching result of the advertisement searching means 204, so that the delivery company can select the advertisement of the highest inserting rate. Since the advertisements included in the advertisement searching result are corresponding to the web page 25a to be printed, the related information, and the personal information of user who instructs the printing, the advertiser 40 can obtain the high advertisement effect. Moreover, since the possibility that advertisements not printed in the past is inserted in the web page gets increased more, so that users can receive various advertisements.

In case where the advertiser 40 wants to give the same advertisement to the same user repeatedly in order to obtain the high advertisement effect, it may be arranged that the advertisement inserting rate change according to the number of the advertisement inserting. For instance, the more the number of the advertisement inserting increases, the more the inserting rate increases. Thereby, it is possible to control the decline of the priority order because the number of inserting increases.

It can be arranged that an advertisement be selected on the basis of either the advertisement inserting rate or the inserting log. For instance, an advertisement to be inserted in the web page 25a may be selected at random from the advertisements decided that those were not printed in the past by referring to the inserting log. And regardless of that the advertisement was printed in the past or not, the advertisement of higher inserting rate may be selected preferentially.

Regarding the advertisement correspondence information, the advertisement is not always necessary to be correlated with all of the web page 25a, the related information, and the personal information, but the advertisement may be correlated with either one of them or a combination of two of them.

By the way, it can be considered that the content of advertisement identified by an advertisement ID changes even though the advertisement ID is the same. That is to say, it is a case that the same advertisement ID is applied to the advertisement of the same product even if the content of the advertisement changes.

In this case, when it is judged that the advertisement was printed in the past or not by whether the advertisement ID is included in the inserting log or not as described above, it happens that the advertisement is excluded from objects to be selected and the priority order gets down even if the content of the advertisement changes.

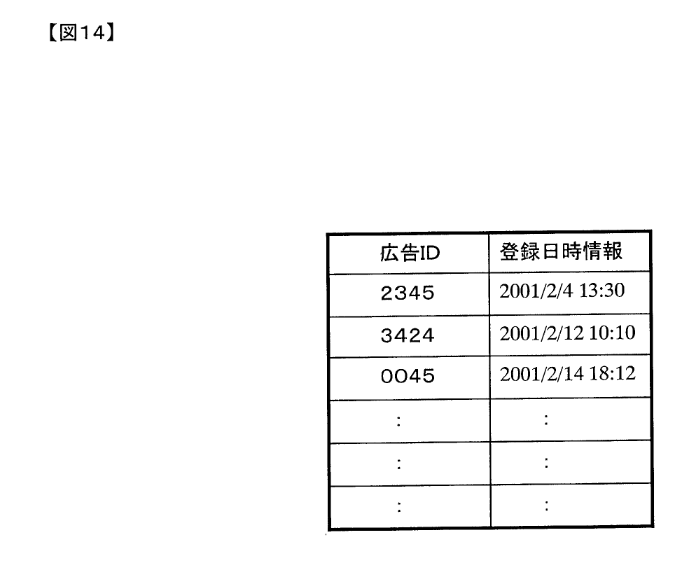

Therefore, as shown in FIG. 14, the inserting log of the advertisement is arranged to include not only the advertisement ID but also the log of registration time information representing the time when the advertisement was registered in the storage means 25. The advertisement selecting means 205 can judge that the advertisement was printed in the past or not by whether the registration time information included in the inserting log is the latest or not.

The registration time information may be stored in the advertisement correspondence information whenever the advertiser 40 changes the content of the advertisement. In this case, the registration time information has been included in the inserting log when the advertisement is inserted in the web page 25a, and the registration time information gets old if the content of the advertisement changes after the advertisement was inserted in the web page 25a.

Accordingly, even if the same advertisement ID, the advertisement selecting means 205 can judge whether the advertisement was printed in the past or not.

The advertisement correspondence information may correlate either one of the web page 25a, the related information, or the personal information with advertisement storage location information representing a location of storage storing the advertisement itself and the advertisement ID. The advertisement storage location information is a URL, for example. In such case, the advertisement selecting means 205 accesses to the storage location represented by the advertisement storage location information included in the searching result and then acquires the advertisement ID. By deciding whether the acquired advertisement ID is included in the inserting log or not, it is judged that the advertisement stored in the storage location was printed in the past or not.

If the registration time information is also stored in the storage location, even when the content of the advertisement stored in the storage location changes, the advertisement selecting means 205 can judge whether the advertisement was printed in the past or not, in a same way as the above description.

Embodiment 7

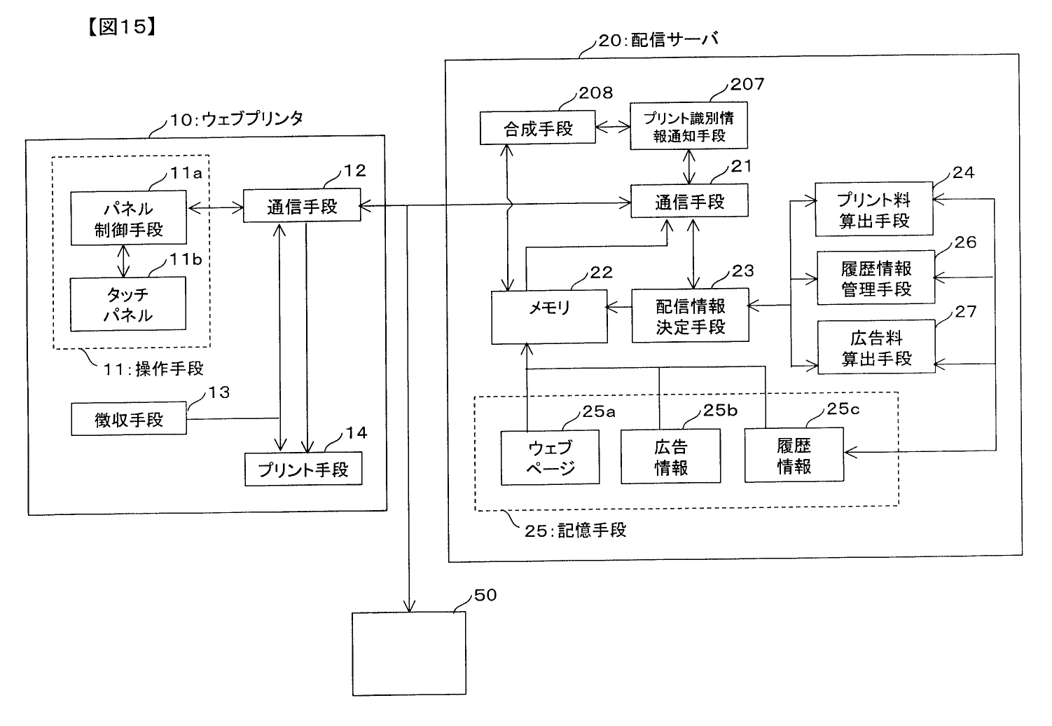

In the embodiment 1, a user operates a printing instruction and so on by means of the touch panel 11b provided in the web printer 10. It is also possible to execute the operations like the printing instruction from a terminal other than the web printer 10. In this case, a user's terminal 50 is connected with the delivery server 20, as shown in FIG. 15.

The user's terminal 50 is an intelligent terminal, such as a personal computer, a personal digital assistant, and a mobile phone; those that a user applies to the operation like the printing instruction.

In case where a user operates the printing instruction by using the terminal 50 other than the web printer 10 for printing the web page 25a, there is a possibility that it is hard to recognize which user is operating the instruction.

By combining and printing a name and ID of user that operates the printing instruction, it is possible to recognize the difference of printing image of each user even when a plurality of users use the same web printer 10. However, it causes to increase a risk that the personal information of each user leaks to the third party.

Therefore, the delivery server 20 shown in FIG. 15 comprises printing ID information notifying means 207. The printing ID information notifying means 207, when the request to send web page to the web printer 10 is issued from the user's terminal 50, allocates a printing ID information to the request in order to identify the request. That is to say, the printing ID information is for identifying the printing (job) generated by the request. The printing ID information notifying means 207 notifies the user's terminal 50 of the printing ID information.

Moreover the printing ID information notifying means 207 outputs the printing ID information to combining means 208. The combining means 208 combines the printing ID information with the printing image of the web page 25a.

It is the printing image of the web page 25a combined with the printing ID information that the web printer acquires.

The printing ID information cannot be concerned with the personal information of the user. Therefore, if the printing image is distinguished from others by using the printing ID information, it is possible to reduce the risk that the personal information leaks out.

Embodiment 8

When a user instructs the web printer 10 to print a desired web page 25a, a user may input ID information such as an ID code for identifying the web page 25a or a URL of a location storing the web page 25a.

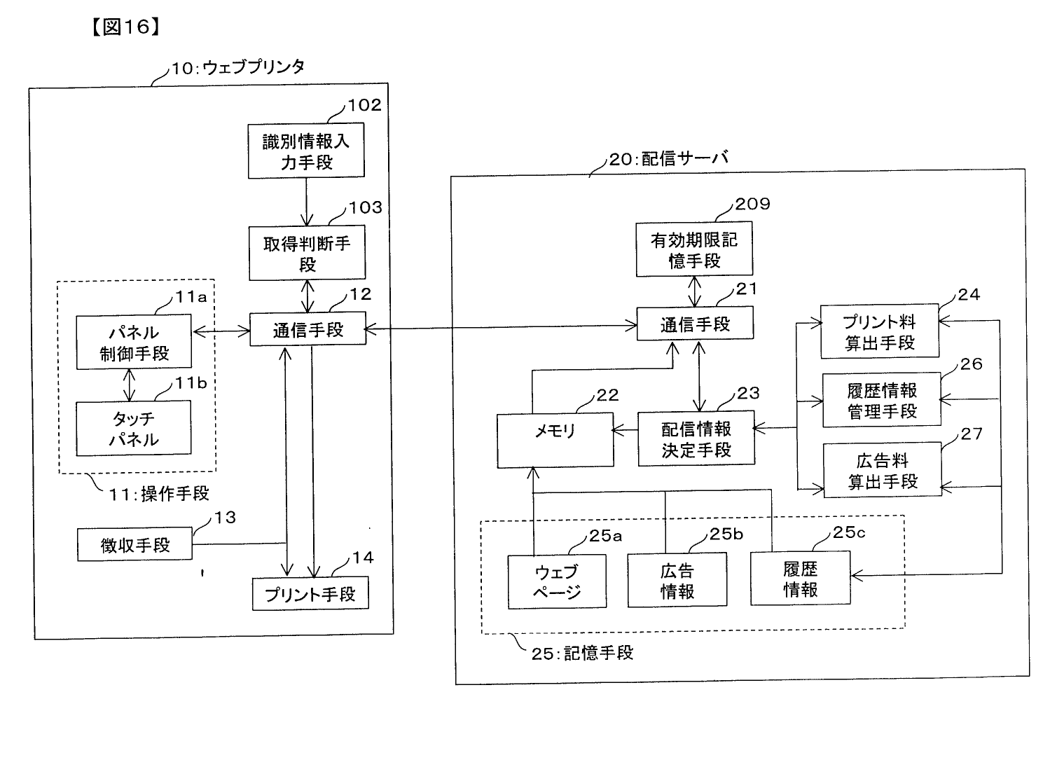

The web printer 10 shown in FIG. 16 comprises ID information inputting means 102 for such operation. It is needless to say that the ID information inputting means 102 can be materialized by the touch panel 11b.

But there is a possibility that the web page 25a identified by the ID code and the web page 25a stored in the same URL will change.

In such case, when a user directly inputs the ID code or the URL in order to print the desired web page 25a, other different web page 25a is printed out.

Therefore, the delivery server 20 shown in FIG. 16 comprises valid term storage means 209 for storing the term for which the ID information is valid. And, the web printer 10 further comprises acquisition judging means 103. At the time the ID information is inputted by the ID information inputting means 102, the acquisition judging means 103 acquires the valid term of the ID information stored in the valid term storage means 209. And then according to the valid term thus acquired, the acquisition judging means 103 judges whether the web page identified by the ID information should be acquired from the delivery server 20 or not. If the present time is in the valid term of the ID information, the acquisition judging means 103 judges that the web page 25a identified by the ID information should be acquired from the delivery server 20. In this case, the web printer 10 sends a request to send the web page toward the delivery server 20. On the contrary, if the present time is on the expiration of the ID information, the acquisition judging means 103 judges that the web page 25a identified by the ID information should not be acquired from the delivery server 20. In this case, the request to send the web page is not issued; meanwhile the touch panel 11b displays the message, for example. Thereby it is possible to avoid the wasted printing.

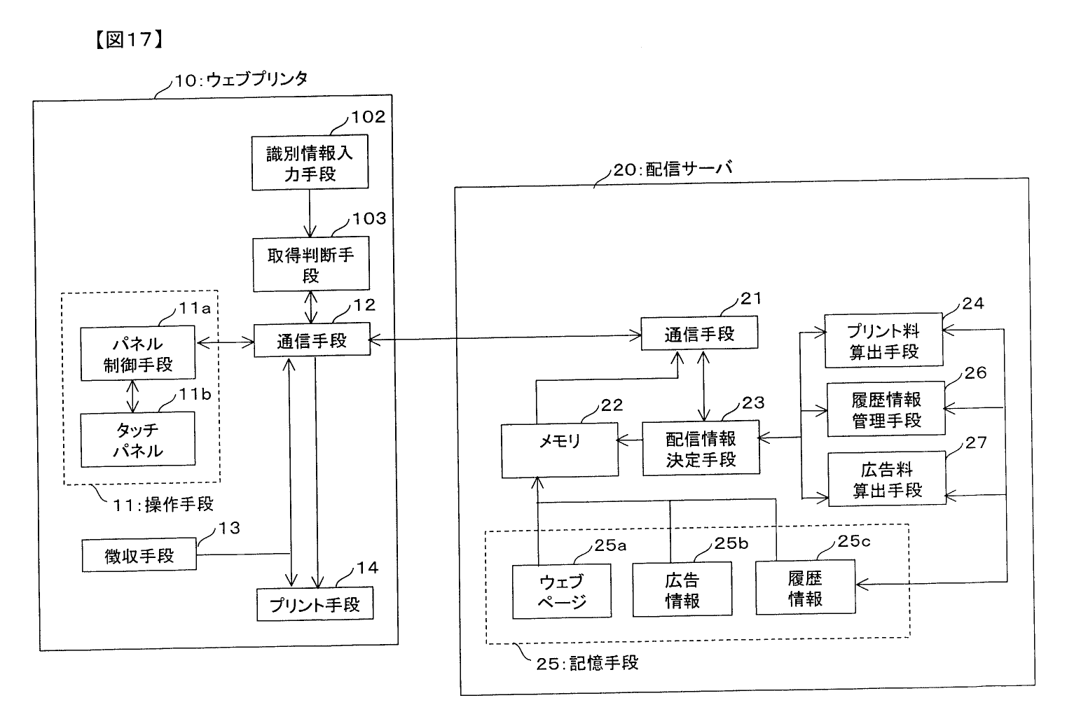

Moreover, the valid term of the ID information can be contained in the ID information itself. For instance, it is arranged that the valid term be used as a name of the lowest layer of directory represented by the URL. In this case, it is not necessary for the delivery server 20 to comprise the valid term storage means 209, as shown in FIG. 17. Without acquiring the valid term of the ID information from the valid term storage means 209, the acquisition judging means may judge, in accordance with the valid term included in the ID information inputted from the ID information inputting means 102, that the web page 25a identified by the ID information should be acquired from the delivery server or not.

Even if the web page 25a identified by the ID information changes, when the web page 25a is imparted with a different name, it is possible to judge by confirming the name by the user whether the web page 25a should be printed or not.

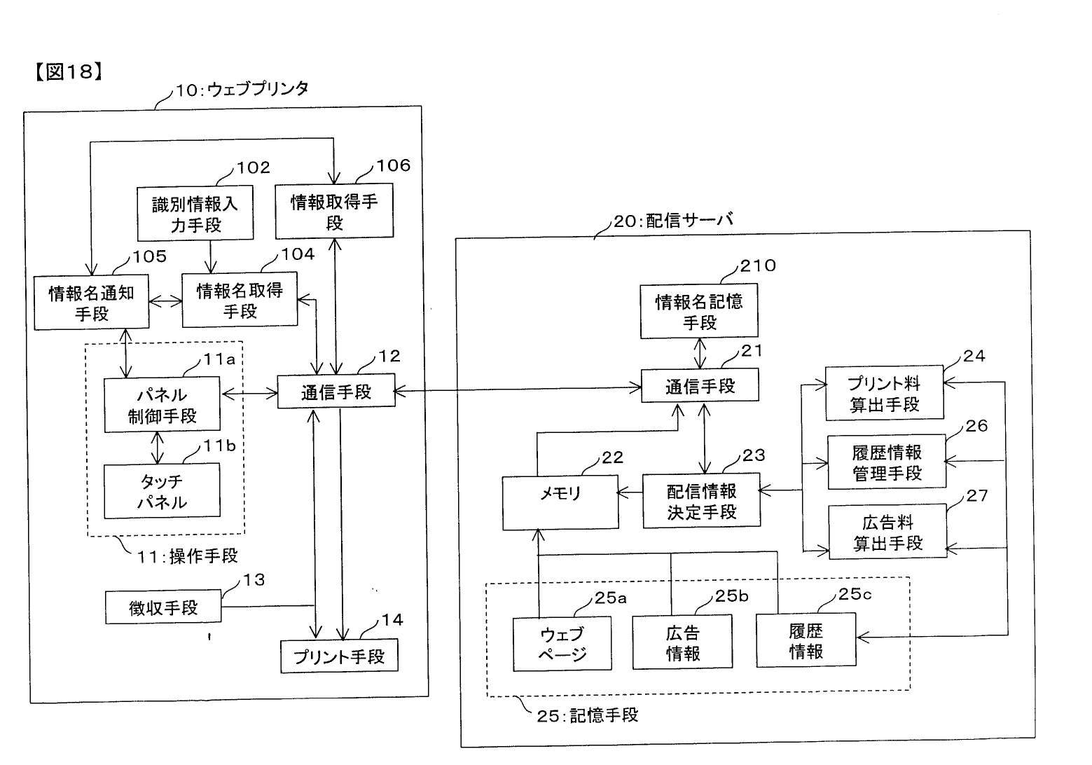

The delivery server 20 shown in FIG. 18 comprises information name storage means 210 for storing a name of the web page 25a instead of the valid term storage means 209. The web printer 10 comprises information name acquisition means 104. The information name acquiring means 104 acquires the name of the web page 25a identified by the ID information from the information name storage means 210 when the ID information is inputted from the ID information inputting means 102.

The information name acquiring means 104 acquires the name of the web page 25a and then outputs it to the information name notifying means 105. The information name notifying means 105 makes the panel control means 11a to control the touch panel 11b to display thus acquired name of the web page 25a, thereby the name of the web page 25a is notified to a user.

And even if the information acquiring means 106 receives the notice from the information name notifying means 105 and when a user does not cancel the acquisition of the web page 25a, the information acquiring means 106 acquires the web page 25a from the delivery server 20 by using the communication means 12.

Others

Furthermore, the invention may adopt various methods as described hereafter.

(Management of Personal Information and Setup Location Information)

For instance, it is preferable to provide a user who lives in Osaka with information with the content related to the living district of the user, Osaka. Additionally, it is preferable to provide a user of the web printer 10 set up at Utsunomiya with information with the content related to Utsunomiya district. Moreover, when a user living in Osaka uses the web printer 10 set at Utsunomiya, it is preferable to provide this user with information with content related to both Osaka and Utsunomiya.

Therefore, it is arranged in the invention that while the personal information of user (“Osaka”, for example) is correlated with the user ID, the setup location information of the web printer 10 (“Utsunomiya”, for example) is correlated with the machine ID. And information of the correlation between these is managed on the storage means 25 in the delivery server 20. Thereby, the user ID and the machine ID are transmitted from the web printer 10 to the delivery server 20 together with the request to send the web page, so that it is possible to provide the user with the web page 25a and the advertisement information 25b with the content taking into consideration the personal information of user and the setup location information of the web printer 10.

Moreover, the web printer 10 may comprises a reading means for reading magnetic card such as a prepaid card (which is not shown in the drawing). In such case, it may be convenient for a user that the user ID is read by the reading means rather than that the user ID is inputted from the touch panel 11b by the user. The fee collecting method except the prepaid card may be the payment with credit card or the withdrawing from bank account (strictly speaking, this method is not the one that the information is printed after the fee is collected in fact, but is practically the same one because of the contract). The machine ID was stored in the storage means (not shown) in the web printer 10 in advance.

In this embodiment, “Osaka” that is a user's address is represented as the personal information of user. But the personal information may adopt the sex of user, the age of user, or etc. According to this arrangement, it is possible to provide a user with the web page 25a and the advertisement information 25b taking into consideration the sex, the age and etc.

Considering the kind of the web page 25a to be printed, it may determine the advertisement information 25b to be combined with the web page 25a. According to this arrangement, it is possible to provide a user with effective advertisements like the web page 25a related to the fashion is combined with a want ad requested from the advertiser 40 of the fashion world.

(A Printer with a Built-in Mobile Phone)

To print the web page by a conventional home web printer, it is necessary to complete various configurations for connecting with telephone line, such as the configuration of access point, for example. However, in order to configure the nearest access point, a user has to recognize the physical location of the web printer. Like this, performing such various configurations has been a large burden for the user.

Therefore, the web printer 10 may install a mobile phone. Thus arranged web printer 10 can get into a state ready for printing the web page 25a simply by being plugged in an outlet. And it is possible to specify the physical location of it, so that the configuration of the access point can be performed automatically. Besides, the technology that a mobile phone can specify its physical location has been well known in public, therefore the explanation is not described here.

In addition, if the web printer 10 installs the mobile phone, it is possible to provide a web printer 10 working at very low power by applying the algorithm that the switch is turned on at receiving a call.

(Optimization Processing)

It is configured in the above description that the “web page 25a” is simply transmitted from the delivery server 20 to the web printer 10. The transmitted web page 25a is preferable to be in a format not for outputting to a display but for outputting to a printer. That is to say, the optimization of web page 25a for the printing should be performed on a side of the delivery server 20 that has a high capability of processing rather than on a side of the web printer 10, thereby it is possible to reduce the processing time. It is general that the data size is compressed down by the optimization; accordingly the communication time gets to be shortened. In addition, it is needless to say that the communication time can be shortened more by adopting a method that a compressed data is transmitted from the delivery server 20 to the web printer 10 and then the compressed data is decompressed on the side of the web printer 10.

Besides, as a method that carries out the speedy printing the following can be found: information and advertisements available to many users are transmitted from the delivery server 20 to the web printer 10 in advance. For instance, it is preferable that information updated regularly, such as newspaper information, are transmitted from the delivery server to the web printer 10 every time it is updated. Since such configuration does not require the above transmission time, it is possible to shorten the printing time as much as the transmission time.

In future it is expected that terminal devices vary in type not only like personal computers but also like printers, PDA (Personal Digital Assistant), telephones, and televisions. Therefore, the delivery server 20 is preferred to provide each destination terminal with data in a format optimized to a destination device, even if the data is the same one. Such information providing system can be carried out by a configuration that a terminal side notifies the delivery server 20 of its type of terminal (for instance, the communication means 12 of the web printer 10 notifies the delivery server of a “printer”).

(Prevention of Overlapping Printing)

A user can usually acquire the latest information by frequently printing information updated momentarily like the newspaper information with the web printer 10. However, in case where the same information is printed frequently like this, there is a problem that the overlapped information is printed.

When the web page 25a to be printed was printed in the past, it is preferable that an object of printing should be only updated parts (which are printed for the first time) not all of them. Accordingly, the printing fee gets down as much as the overlapped information is not printed. Besides the judgment whether the web page was printed in the past or not can be performed by referring to the log information 25c of the storage means 25.

Moreover, it is obvious that the conventional newspapers (newspaper documents) are delivered to subscriber everyday; on the other hand it is probable that the electronic newspapers may be distributed per every three hours or per every 3 days. Therefore, a user who accesses to a serial (articles on the murder investigation) after three days' absence cannot understand the content sufficiently because some parts of the information provided for such term are missing. It is a trouble for user.

Here, in this case, it is preferable that the articles provided for the term are edited efficiently. According to this configuration, it is possible to provide information without missing parts to a user who accesses after three days' absence. Besides, the judgment whether a user is accessing after three days' absence or not can be performed by referring to the log information 25c of the storage means 25.

As described above, the invention is configured so as to calculate the printing fee on the basis of the providing fee of the Internet information, so that it is possible to perform the proper accounting for both the information provider and the user. That is to say, it is configured in the invention that according to the size and content of the Internet information the amount paid from the delivery company to the information provider is made to be changeable, while according to the change of the amount the printing fee collected from a user by the delivery company can be increased or reduced.

In addition, it is arranged in the invention that the advertisement rate per printing multiplied by the number of printings be calculated as the printing fee, so that it is possible to make the proper accounting for both the user and the advertiser. That is to say, the burden of user can be reduced by collecting the advertisement rate from the advertiser, and then the advertisement rate collected from the advertiser is corresponding to the number of printings.

The invention claimed is:

1. A web print system including a web printer acquiring Internet information from a delivery server and printing the Internet information, which comprising:
printing fee calculating means for calculating a printing fee on the basis of at least either one of a running cost needed for printing, a providing fee of Internet information and an advertisement rate per printing; and
wherein the web printer acquires the Internet information from the delivery server and prints the Internet information when the printing fee calculated by the printing fee calculating means is collected from a user.

2. A web print system according to claim 1, which further comprising:
operating means for inquiring of a user whether a printing mode of the web printer is to be the color mode or the monochrome mode; and
wherein the printing fee calculating means calculates a printing fee on the basis of the selected printing mode.

3. A web print system according to claim 1, which further comprising:
operating means for inquiring of a user whether an advertisement to be inserted in the Internet information should be printed or not; and
wherein the printing fee calculating means calculates a printing fee according to whether the advertisement should be printed or not.

4. A web print system according to claim 1, which further comprising:
operating means for inquiring of a user a kind of advertisement to be inserted in the Internet information; and
wherein the printing fee calculating means calculates a printing fee on the basis of the kind of the advertisement.

5. A web print system according to claim 1, which further comprising:
log storage means for storing log information of internet information printed in the past; and
wherein the printing fee calculating means comprises judging means for judging by the log information whether the internet information was printed in the past or not; and,
the printing fee calculating means calculates a printing fee on the basis of not the providing fee of the Internet information but the fee to which the providing fee is discounted when the judging means determined that the internet information was printed in the past.

6. A web print system according to claim 1, which further comprising:
log storage means for storing log information of Internet information printed in the past;
judging means for judging by the log information whether the internet information was printed in the past or not; and
notifying means, if the judging means determined that the Internet information was printed in the past, the notifying means for notifying a user of the judgment result.

7. A web print system according to claim 1, which further comprising:
operating means for displaying the printing fee calculated by the printing fee calculating means and inquiring of a user whether the printing should be performed at the displayed printing fee or not.

8. A web print system according to claim 1, which further comprising:
layout adjusting means for adjusting a layout of the Internet information; and
wherein the printing fee calculating means calculates a printing fee on the basis of the adjusted layout.

9. A web print system according to claim 8, wherein the layout adjusting means adjusts the layout so as not to generate any wasted space.

10. A web print system according to claim 8, wherein the layout adjusting means adjusts at least either one of a style of type, a font of type, a size of image, or a quality of image.

11. A web print system according to claim 1, wherein the printing fee calculating means comprises use of coloring agent estimating means for estimating used volumes of coloring agents needed for printing the Internet information on the basis of the printing image of the Internet information; and cost of coloring agents calculating means for calculating costs of coloring agents included in the printing cost needed for printing on the basis of the result estimated by the use of coloring agent estimating means.

12. A web print system including a web printer for acquiring Internet information from a delivery server and printing the Internet information, which comprising:
advertisement rate calculating means for calculating an advertisement rate on the basis of at least either one of the number of advertisement printing, the term of advertisement inserting, the size or content of the Internet information printed with the advertisement or the price decided at an auction of advertisers intending to insert advertisements.

13. A web print system according to either claim 1 or 12, which further comprising:
delivery information deciding means for deciding Internet information or advertisement having content corresponding to and on the basis of at lest either one of personal information of user, location information at which a web printer is setup, or a kind of the Internet information.

14. A web print system according to claim 1, wherein the printing fee calculating means excludes a running cost needed for printing advertisement from the printing fee.

15. A web print system according to claim 14, wherein the printing fee calculating means comprises advertisement cost calculating means for calculating a running cost needed for printing an advertisement on the basis of the printing image of the advertisement.

16. A web print system according to claim 1, which comprising:
advertisement correspondence information storage means for storing advertisement correspondence information correlating an advertisement with at least either one of Internet information, information related to Internet information or personal information;
inserting rate storage means for storing a inserting fee of advertisement;
inserting log storage means for storing inserting log of the advertisement per user;
advertisement searching means for searching an advertisement corresponding to at least either one of Internet information to be printed, related information, or personal information of user on the basis of the advertisement correspondence information; and
advertisement selecting means for selecting an advertisement to be inserted in the printing Internet information from advertisements included in the searching result of the advertisement searching means on the basis of at least either one of the advertisement inserting fee or the inserting log.

17. A web print system according to claim 16, wherein the advertisement selecting means selects an advertisement to be inserted in the printing Internet information from advertisements determined not to be printed in the past on the basis of the inserting log per user out of advertisements included in the searching result of the advertisement searching means.

18. A web print system according to claim 17, wherein the inserting log includes a log of registration time information representing the date and time an advertisement was registered, and the advertisement selecting means judges whether the advertisement was printed in the past or not by whether the registration time information is the latest or not.

19. A web print system according to claim 17, wherein the advertisement correspondence information correlates advertisement storage information representing storage location storing advertisement itself and advertisement ID information identifying the advertisement with at least one of Internet information, information related to the Internet information, or personal information;
the inserting log includes a log of the advertisement ID information; and
the advertisement selecting means judges whether the advertisement was printed in the past or not by whether the advertisement ID information stored in the storage location is included in the inserting log.

20. A web print system including a web printer acquiring Internet information from a delivery server and printing the Internet information, which comprising:
use of coloring agents for advertisement estimating means for estimating, on the basis of the printing image of an advertisement to be inserted in the Internet information, use of coloring agents needed for printing the advertisement;
cost of coloring agents for advertisement calculating means for calculating the cost of coloring agents on the basis of the result estimated by the use of coloring agents for advertisement estimating means; and
advertisement rate calculating means for calculating an advertisement rate on the basis of the result calculated by the cost of coloring agents for advertisement calculating means.

21. A web print system including a web printer acquiring Internet information from a delivery server and printing the Internet information, which comprising:
printing ID information notifying means for notifying a user's terminal of printing ID information identifying the printing; and
combining means for combining the printing ID information with the printing image of the Internet information.

22. A web print system including a web printer acquiring Internet information from a delivery server and printing the Internet information, which comprising:
ID information inputting means for inputting ID information identifying the Internet information;
valid term storage means for storing a valid term of the ID information;
acquisition judging means for judging whether the Internet information identified by the ID information inputted from the ID information inputting means is to be acquired from the delivery server or not on the basis of the valid term.

23. A web print system including a web printer acquiring Internet information from a delivery server and printing the Internet information, which comprising:
ID information inputting means for inputting ID information identifying the Internet information and including a valid term of the information; and
acquisition judging means for judging whether the Internet information identified by the ID information is to be acquired from the delivery server or not on the basis of the valid term of the ID information inputted by the ID information inputting means.

24. A web print system including a web printer acquiring Internet information from a delivery server and printing the Internet information, which comprising:
ID information inputting means for inputting ID information identifying the Internet information;
information name storage means for storing a name of the Internet information identified by the ID information;
information name acquiring means for acquiring the name of the Internet information identified by ID information when the ID information is inputted by the ID information inputting means;
information name notifying means for notifying a user of the name of the Internet information acquired by the information name acquiring means; and
information acquiring means for acquiring the Internet information from the delivery server when a user does not cancel the acquiring of the Internet information even on receipt of the notification from the information name notifying means.

25. An accounting method of a web print system provided with a web printer acquiring Internet information from a delivery server and printing the Internet information, which comprising:
calculating a printing fee on the basis of at least either one of a running cost needed for printing, a providing fee of the internet information, or an advertising rate per printing;
collecting from a user the printing fee calculated in the step of calculating the printing fee; and
acquiring the Internet information from the delivery server and printing the Internet information when the printing fee is collected.

26. An accounting method of a web print system provided with a web printer acquiring Internet information from a delivery server and printing the Internet information, which comprising:
calculating an advertisement rate on the basis of at least either one of the number of the advertisement printing, the term of the advertisement inserting, the size or content of the internet information printed with the advertisement, the price decided at the auction of advertisers intending to insert advertisements.
